(19) United States
(12) Patent Application Publication
(10) Pub. No.: US 2026/0060276 A1
(43) Pub. Date: Mar. 5, 2026

(54) DETACHABLE DISPENSING DEVICE FOR COLD DRINK AND COLD DRINK MACHINE

(71) Applicant: Guangzhou Xin'an Trading Co., Ltd., Guangzhou (CN)

(72) Inventor: Quan Zhou, Guangzhou (CN)

(21) Appl. No.: 19/078,378

(22) Filed: Mar. 13, 2025

(30) Foreign Application Priority Data
Aug. 29, 2024 (CN) 202422120757.6
Sep. 5, 2024 (CN) 202422184896.5

(51) Int. Cl. A23G 9/28; A23G 9/06; A23G 9/30; A23G 9/52

(52) U.S. Cl. CPC A23G 9/283; A23G 9/06; A23G 9/30; A23G 9/52

(57) ABSTRACT

The application discloses a detachable dispensing device for cold drink and a cold drink machine. The dispensing device for cold drink comprises a dispensing tray, a housing, and a handle; the housing is provided with a first dispensing outlet, the dispensing tray is provided with a second dispensing outlet, the dispensing tray is detachably mounted on the outer side of the first dispensing outlet of the housing, the first dispensing outlet is connected to the second dispensing outlet, and the dispensing tray is configured to seal the first dispensing outlet. In this application, the dispensing tray can be replaced or cleaned separately, which reduces the difficulty of replacing the dispensing tray and solves the problem of difficulty in cleaning the equipment due to the traditional dispensing tray being difficult to disassemble.

### CROSS REFERENCE TO RELATED APPLICATIONS

The present application claims the benefit of Chinese Patent Application Nos. 2024221848965 filed on Sep. 5, 2024 and 2024221207576 filed on Aug. 29, 2024, the contents of which are incorporated herein by reference in their entirety.

### TECHNICAL FIELD

The application relates to the technical field of cold drink machines, specifically to a detachable dispensing device for cold drink and a cold drink machine.

### BACKGROUND ART

Cold drink machines, typically including ice cream machines or slushie machines, are configured to make ice cream or slushies. Traditional designs of cold drink machines often fix the dispensing tray inside the housing. While this design ensures the compactness of the device structure and operational stability to some extent, it also directly leads to a major challenge in daily operation and maintenance, namely the cleaning of the dispensing tray. As the dispensing tray directly contacts the finished ice cream or slushie products and often retains various ingredients and seasonings, it inevitably accumulates dirt, bacteria, and other microorganisms over time, posing a potential threat to food safety.

Specifically, when changing the flavor of ice cream or slushie, staff often need to take complicated steps or use additional tools for cleaning due to the non-removable nature of the dispensing tray. This is not only time-consuming and labor-intensive but may also affect the hygienic quality and taste of subsequent ice cream or slushie products if not cleaned thoroughly. Similarly, during regular cleaning and maintenance of the equipment, a non-removable dispensing tray increases the difficulty and cost of the overall cleaning task.

### SUMMARY

In view of the aforementioned deficiencies, the application proposes a detachable dispensing device for cold drink and a cold drink machine. The dispensing tray is designed to be individually replaceable and maintainable, allowing staff to easily replace or clean it as needed. This modular design significantly simplifies the replacement process and addresses the challenges associated with traditional dispensing trays, which are often difficult to disassemble and clean, thereby enhancing overall equipment maintenance efficiency.

To achieve this objective, the application adopts the following technical solution.

A detachable dispensing device for cold drink and a cold drink machine is provided, comprising a dispensing tray, a housing, and a handle; the housing is provided with a first dispensing outlet, the dispensing tray is provided with a second dispensing outlet, the dispensing tray is detachably mounted on the outer side of the first dispensing outlet of the housing, the first dispensing outlet is connected to the second dispensing outlet, and the dispensing tray is configured to seal the first dispensing outlet.

The handle is mounted on the dispensing tray and is configured to control the opening and closing of the dispensing outlet.

The housing is provided with an inwardly recessed annular groove at the first dispensing outlet, and the side wall of the annular groove is provided with multiple first engaging blocks.

The side of the dispensing tray close to the housing is provided with a ring, the outer side of the ring is provided with multiple second engaging blocks, the first engaging blocks and the second engaging blocks are mutually engaged, and the multiple first engaging blocks correspond one-to-one with the multiple second engaging blocks.

Each first engaging block comprises a first vertical portion and a first horizontal portion that are perpendicular to each other, the end of the first vertical portion away from the first horizontal portion is connected to the inner wall of the annular groove, and the first horizontal portion is flush with the outer surface of the housing.

Each second engaging block comprises a second vertical portion and a second horizontal portion that are perpendicular to each other, the end of the second vertical portion away from the second horizontal portion is connected to the inner wall of the dispensing tray, and the first horizontal portion is flush with the end of the ring.

The length directions of the first vertical portion and the second vertical portion are consistent with the axial direction of the first dispensing outlet.

The side of the second horizontal portion close to the first horizontal portion is provided with a second inclined subsection and a recessed section, and the two ends of the recessed section are connected to two second inclined subsections, respectively.

The side of the first horizontal portion close to the second horizontal portion is provided with a first inclined subsection and a protruding subsection, and the two ends of the protruding subsection are connected to two first inclined subsections, respectively.

The recessed section is engaged with the protruding subsection, and the first inclined subsection is in contact with the second inclined subsection.

The second horizontal portion of each second engaging block is disposed close to the second vertical portion of an adjacent second engaging block.

The first horizontal portion of each first engaging block is disposed close to the first vertical portion of an adjacent first engaging block.

The second dispensing outlet is provided with a vertical grating.

The handle has a frustum structure that gradually tapers from bottom to top.

A cold drink machine using the detachable dispensing device for cold drink.

The technical solution of the application can provide the following beneficial effects.

The dispensing tray is designed to be individually replaceable and maintainable, allowing staff to easily replace or clean it as needed. This modular design significantly simplifies the replacement process and addresses the challenges associated with traditional dispensing trays, which are often difficult to disassemble and clean, thereby enhancing overall equipment maintenance efficiency.

Users only need to align the ring on the dispensing tray with the annular groove and then gently rotate or push it to achieve mutual locking or unlocking of the engaging blocks, which not only improves work efficiency but also reduces operation difficulty and error rates.

### BRIEF DESCRIPTION OF THE DRAWINGS

FIG. 1 is a schematic diagram of an ice cream machine according to one embodiment of the present application;

FIG. 2 is an exploded view of an ice cream machine according to one embodiment of the present application;

FIG. 3 is a schematic diagram of a dispensing tray according to one embodiment of the present application;

FIG. 4 is a schematic diagram of a housing according to one embodiment of the present application;

FIG. 5 is a schematic diagram of a dispensing tray according to another embodiment of the present application;

FIG. 6 is a schematic diagram of a housing according to another embodiment of the present application;

FIG. 7 is an enlarged view of section A in FIG. 5;

FIG. 8 is an enlarged view of section B in FIG. 6.

### REFERENCE NUMBERS

1-dispensing tray; 11-second discharge outlet; 12-ring; 13-second engagement block; 131-second vertical portion; 132-second horizontal portion; 133-second inclined subsection; 134-recessed subsection; 14-grating; 2-housing; 21-first discharge outlet; 22-annular groove; 23-first engagement block; 231-first vertical portion; 232-first horizontal portion; 233-first inclined subsection; 234-protruding subsection; 3-handle.

### DETAILED DESCRIPTION

The following further explains the technical solution of the present application with reference to the accompanying drawings and through specific embodiments.

In the description of the present application, it should be understood that terms such as “length,” “middle,” “upper,” “lower,” “left,” “right,” “top,” and “bottom” indicate orientations or positional relationships based on those shown in the drawings. They are configured solely for the convenience of describing and simplifying the description of the present application, and do not indicate or imply that the device or element referred to must have a specific orientation, be constructed or operated in a specific orientation, and therefore should not be construed as limiting the present application.

Furthermore, the terms “first” and “second” are configured for descriptive purposes only and are not to be construed as indicating or implying relative importance or implicitly specifying the number of technical features indicated. Thus, features defined with “first” and “second” may explicitly or implicitly comprise one or more of such features. In the description of the present application, unless otherwise specified, the term “multiple” means two or more.

In the description of the present application, it should be noted that unless otherwise explicitly provided and limited, the terms “installed,” “spliced,” and “connected” should be understood broadly. For example, they may refer to fixed connections, detachable connections, or integral connections; they may be directly connected or indirectly connected through an intermediary medium; they may refer to internal connectivity between two components. For those skilled in the art, the specific meanings of the aforementioned terms in the present application can be understood based on the specific context.

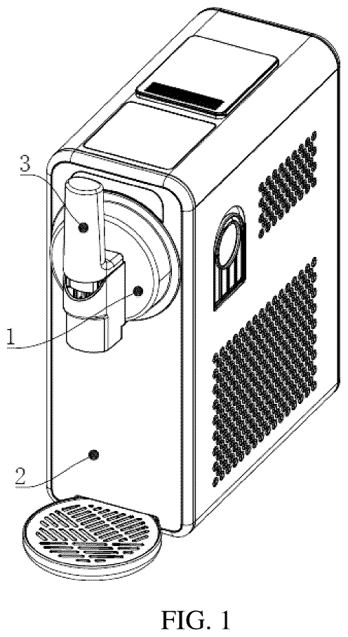

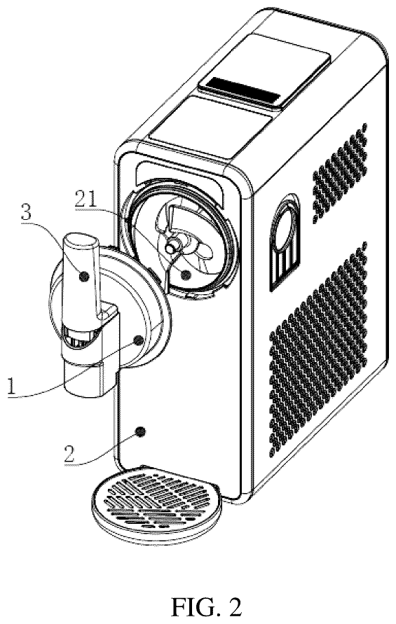

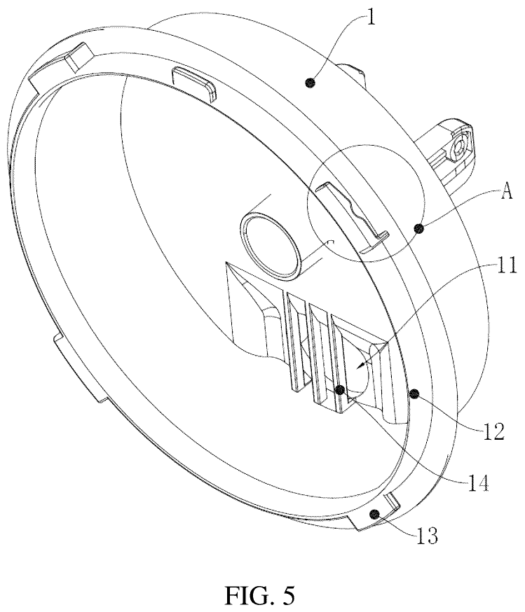

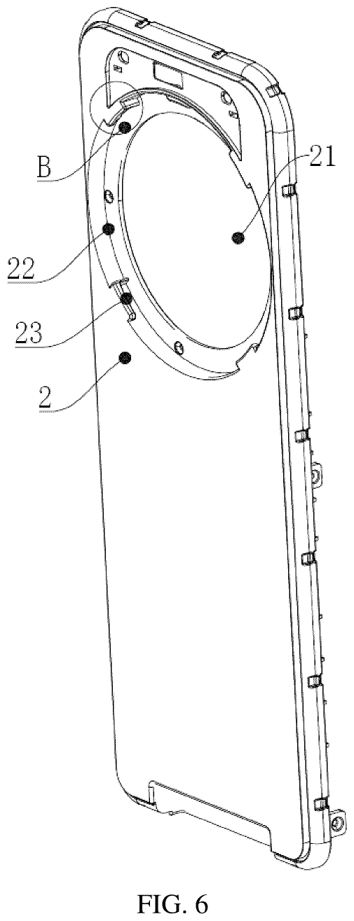

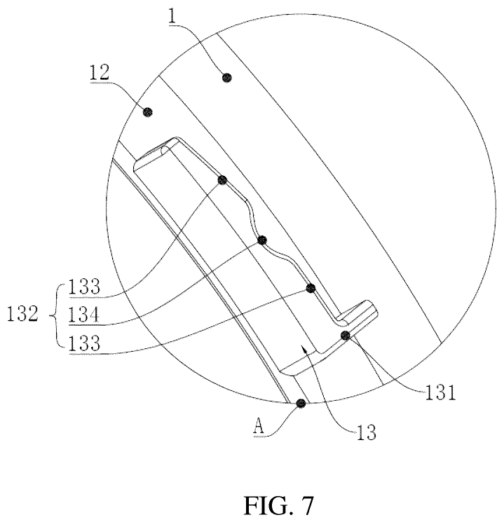

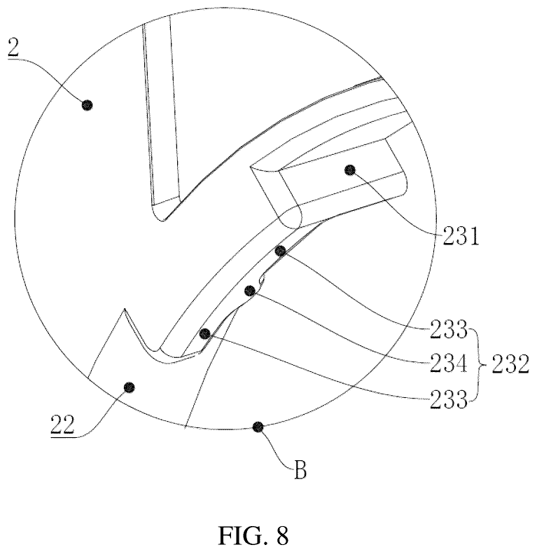

With reference to FIGS. 1 to 8, a detachable dispensing device for cold drink and an ice cream machine according to an embodiment of the present application are described below.

### Embodiment 1

A detachable dispensing device for cold drink comprises a dispensing tray 1, a housing 2, and a handle 3; the housing 2 is provided with a first discharge outlet 21, the dispensing tray 1 is provided with a second discharge outlet 11, the dispensing tray 1 is detachably installed on the outer side of the first discharge outlet 21 of the housing 2, the first discharge outlet 21 is connected to the second discharge outlet 11, and the dispensing tray 1 is configured to seal the first discharge outlet 21.

The handle 3 is installed on the dispensing tray 1 and configured to control the opening and closing of the discharge outlet.

In this embodiment of the detachable dispensing device for cold drink, the dispensing tray 1 is detachably installed inside the housing 2, sealing the first discharge outlet 21 within the housing 2. By activating the handle 3, ice cream or sorbet inside the housing 2 can be discharged through the second discharge outlet 11, thereby completing the dispensing of ice cream or sorbet.

It should be noted that the design of the detachable installation of the dispensing tray 1 inside the housing 2 using the handle 3 makes equipment maintenance and cleaning extremely convenient. When it is necessary to clean or replace the dispensing tray 1, users do not need to disassemble the entire device; quick installation and removal can be achieved with simple operations, greatly saving time and labor costs and improving work efficiency. At the same time, this design also facilitates the adjustment or replacement of dispensing trays 1 of different specifications and materials according to production needs, enhancing the flexibility and adaptability of the equipment.

Since the dispensing tray 1 is a structure that can be replaced and maintained separately, it allows staff to replace or clean the dispensing tray 1 independently, reducing the difficulty of replacing the dispensing tray 1 and solving the problem of difficulty in cleaning traditional dispensing trays 1 due to their difficult removal.

The housing 2 is provided inward at the first discharge port 21 to form an annular groove 22, and the side wall of the annular groove 22 is provided with multiple first engaging blocks 23.

The dispensing tray 1 is provided with a ring 12 on the side close to the housing 2, and the outer side of the ring 12 is provided with multiple second engaging blocks 13. The first engaging blocks 23 and the second engaging blocks 13 are engaged with each other, with each of the multiple first engaging blocks 23 corresponding to one of the multiple second engaging blocks 13.

The one-to-one correspondence design of the first engaging blocks 23 and the second engaging blocks 13 makes the installation and disassembly process simple and quick. Users only need to align the ring 12 on the dispensing tray 1 with the annular groove 22 and then gently rotate or push it to lock or unlock the engaging blocks, which not only improves work efficiency but also reduces operation difficulty and error rate.

The first engaging block 23 comprises a first vertical portion 231 and a first horizontal portion 232 that are perpendicular to each other. The end of the first vertical portion 231 far from the first horizontal portion 232 is connected to the inner wall of the annular groove 22, and the first horizontal portion 232 is flush with the outer surface of the housing.

The second engaging block 13 comprises a second vertical portion 131 and a second horizontal portion 132 that are perpendicular to each other. The end of the second vertical portion 131 far from the second horizontal portion 132 is connected to the inner wall of the dispensing tray 1, and the first horizontal portion 232 is flush with the end of the ring 12.

The length directions of the first vertical portion 231 and the second vertical portion 131 are consistent with the axial direction of the first discharge port.

Since both the first engaging block 23 and the second engaging block 13 have an L-shaped structure, they can increase the strength and rigidity of the ring 12 and the annular groove 22. The first vertical portion 231 is securely connected to the inner wall of the annular groove 22, and the second vertical portion 131 is securely mounted to the inner wall of the dispensing tray 1, ensuring that the first engaging block 23 and the second engaging block 13 do not easily loosen or fall off when subjected to force. The first horizontal portion 232 is flush with the outer surface of the housing, and the second horizontal portion 132 is flush with the end of the ring 12, further enhancing the strength and stability of the connection, making the connection between the housing 2 and the dispensing tray 1 more secure and reliable, thereby being able to withstand greater external forces and impacts.

Moreover, the L-shaped design allows the first engaging block 23 and the second engaging block 13, when combined, to achieve preliminary fixation through the relative positioning of the first vertical portion 231 and the second vertical portion 131, and to form a more stable supporting surface through the mutual abutment of the first horizontal portion 232 and the second horizontal portion 132. This dual function significantly enhances the overall stability and load-bearing capacity of the connection, reducing the risk of loosening or deformation due to external forces.

In addition, rotating the dispensing tray 1 in the opposite direction causes the first engaging blocks 23 and the second engaging blocks 13 to move away from each other, allowing staff to quickly disassemble the dispensing tray 1 when maintenance or replacement is needed, shortening maintenance time and improving the overall availability and operational efficiency of the equipment.

The second horizontal portion 132 of the second engaging block 13 is located close to the second vertical portion 131 of an adjacent second engaging block 13.

The first horizontal portion 232 of the first engaging block 23 is located close to the first vertical portion 231 of an adjacent first engaging block 23.

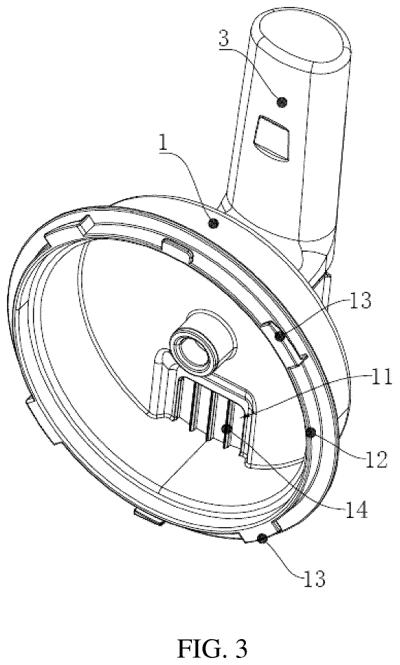

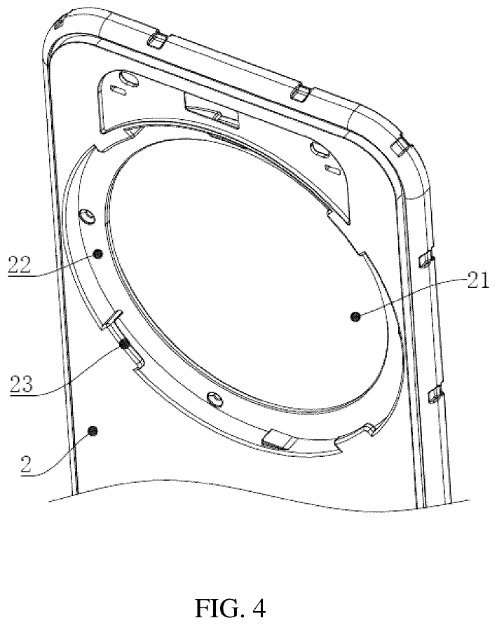

Referring to FIGS. 3 and 4, the first engaging blocks 23 and the second engaging blocks 13 are arranged clockwise, which greatly simplifies the assembly process of the dispensing tray 1. Rotating the dispensing tray 1 counterclockwise separates the first engaging blocks 23 and the second engaging blocks 13, allowing for quick disassembly of the dispensing tray 1. Rotating the dispensing tray 1 clockwise allows the first engaging portions to naturally and smoothly engage with the second engaging portions without the need for additional adjustment or alignment steps, significantly improving work efficiency and reducing operation time.

The second discharge port 11 is provided with a vertical grating 14.

The vertical grating 14 effectively blocks large impurities or incompletely mixed ingredients that may be present in ice cream or sorbet, ensuring the purity and safety of the discharge. At the same time, the design of the grating 14 helps control the flow rate of ice cream or sorbet, making it more stable and uniform, and avoiding waste or clogging due to excessive discharge. This not only improves the efficiency of ice cream or sorbet production but also reduces downtime for cleaning caused by improper operation, enhancing overall production efficiency.

The described handle 3 features a frustum structure that gradually tapers from bottom to top. The frustum shape design gives the lower part of the handle 3 a larger diameter, providing a greater supporting area and enhancing stability when the user holds it.

In this cold drink dispenser solution, the dispensing mechanism is designed to be separately replaceable and maintainable, allowing staff to replace or clean the dispensing tray 1 independently, reducing the difficulty of replacing the tray 1 and addressing the issue of traditional trays being hard to dismantle, which complicates equipment cleaning.

### Embodiment 2

This embodiment differs from Embodiment 1 in that: the side of the second horizontal portion 132 close to the first horizontal portion 232 is provided with a second inclined subsection 133 and a recessed subsection 134, with the recessed subsection 134 connecting two said second inclined subsections 133 at both ends.

The side of the first horizontal portion 232 close to the second horizontal portion is provided with a first inclined subsection 233 and a protruding subsection 234, with the protruding subsection 234 connecting two said first inclined subsections 233 at both ends.

The recessed subsection 134 engages with the protruding subsection 234, and the first inclined subsection 233 abuts against the second inclined subsection 133.

It is worth noting that the precise engagement design of the recessed subsection 134 and the protruding subsection 234 enables a tighter locking fit between the first clamping block 23 and the second clamping block 13, effectively preventing relative displacement due to vibration or external forces, thereby enhancing the overall structural stability and reliability.

The abutment between the first inclined subsection 233 and the second inclined subsection 133 not only increases the contact area but also, through the design of the inclination angle, guides and disperses the stress generated during the clamping process, effectively reducing local stress concentration and extending the service life of the clamping structure.

When the protruding subsection 234 is fully inserted into the recessed subsection 134, the presence of the inclined subsections creates a wedge-like locking effect. This self-locking mechanism enables the clamping structure to generate greater resistance when subjected to reverse tensile forces, further enhancing the stability of the connection.

The technical principles of the present invention are described above in conjunction with specific embodiments. These descriptions are intended solely to explain the principles of the invention and should not be construed in any way as limiting the scope of protection of the invention. Based on this explanation, those skilled in the art can envision other specific implementations of the invention without exerting creative effort, and these implementations will fall within the scope of protection of the invention.

What is claimed is:

1. A detachable dispensing device for cold drink, comprising a dispensing tray, a housing, and a handle; the housing is provided with a first dispensing outlet, the dispensing tray is provided with a second dispensing outlet, the dispensing tray is detachably mounted on the outer side of the first dispensing outlet of the housing, the first dispensing outlet is connected to the second dispensing outlet, and the dispensing tray is configured to seal the first dispensing outlet;
the handle is mounted on the dispensing tray and is configured to control the opening and closing of the dispensing outlet.

2. The detachable dispensing device for cold drink according to claim 1, wherein the housing is provided with an annular groove that is recessed inward at the first dispensing outlet, and the side wall of the annular groove is provided with multiple first engagement blocks;
the side of the dispensing tray that is close to the housing is provided with a ring, the outer side of the ring is provided with multiple second engagement blocks, the first engagement blocks and the second engagement blocks are engaged with each other, and the multiple first engagement blocks correspond one-to-one with the multiple second engagement blocks.

3. The detachable dispensing device for cold drink according to claim 2, wherein the first engagement block comprises a first vertical portion and a first horizontal portion that are perpendicular to each other, the end of the first vertical portion far from the first horizontal portion is connected to the inner wall of the annular groove, and the first horizontal portion is flush with the outer surface of the housing;
the second engagement block comprises a second vertical portion and a second horizontal portion, perpendicular to each other, the end of the second vertical portion far from the second horizontal portion is connected to the inner wall of the dispensing tray, and the first horizontal portion is flush with the end of the ring;
the length directions of the first vertical portion and the second vertical portion are consistent with the axial direction of the first dispensing outlet.

4. The detachable dispensing device for cold drink according to claim 3, wherein the side of the second horizontal portion close to the first horizontal portion is provided with a second inclined subsection and a recessed subsection, the two ends of the recessed subsection are respectively connected to two second inclined subsections;
the side of the first horizontal portion close to the second horizontal portion is provided with a first inclined subsection and a protruding subsection, the two ends of the protruding subsection are respectively connected to two first inclined subsections;
the recessed subsection is engaged with the protruding subsection, and the first inclined subsection and the second inclined subsection are in contact with each other.

5. The detachable dispensing device for cold drink according to claim 4, wherein the second horizontal portion of the second engagement block is disposed close to the second vertical portion of an adjacent second engagement block;
the first horizontal portion of the first engagement block is disposed close to the first vertical portion of an adjacent first engagement block.

6. The detachable dispensing device for cold drink according to claim 1, wherein the second dispensing outlet is provided with a vertical grating.

7. The detachable dispensing device for cold drink according to claim 1, wherein the handle is a frustum structure that gradually tapers from bottom to top.

8. A cold drink machine, wherein it is provided with a detachable dispensing device for cold drink according to claim 1.
